(19) United States
(12) Patent Application Publication
(10) Pub. No.: US 2005/0194767 A1
(43) Pub. Date: Sep. 8, 2005

(54) Gas bag module, in particular for a knee gas bag

(75) Inventors: Werner Freisler, Aalen (DE); Gerd Zischka, Schwaebisch Gmuend (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive GmbH

(21) Appl. No.: 11/065,503

(22) Filed: Feb. 24, 2005

(30) Foreign Application Priority Data
Mar. 5, 2004 (DE) 10 2004 010 869.2

(51) Int. Cl. B60R 21/16

(52) U.S. Cl. 280/728.2

(57) ABSTRACT

A gas bag module (10), in particular for a knee gas bag, includes a housing (12), a gas generator (16) and a gas bag (14). The gas generator (16) and the gas bag (14) form a unit which is floatingly mounted in the interior of the housing (12).

### BACKGROUND OF THE INVENTION

The invention relates to a gas bag module, in particular for a knee air bag, including a housing, a gas generator and a gas bag.

Knee air bags are provided in particular in motor vehicles destined for the U.S. market or countries in which the wearing of safety belts is not statutory. In a frontal collision the knee air bag permits to restrain the knees of the vehicle occupant. This prevents the vehicle occupant from slipping into the region below the instrument carrier. The upper trunk of the vehicle occupant is caught by a conventional gas bag.

Usually, the individual components of a knee gas bag module are fitted to a fastening plate made of metal. Should the gas bag be activated, this fastening plate takes up all response forces and supports the gas bag against the vehicle occupant. The fastening plate further serves as a housing and thus as a protective cover against damage and soiling of the individual components. Moreover, it may be designed in such a manner that it acts as an ejection channel.

Such a metallic fastening plate is usually installed from the rear of the instrument carrier, i.e. from the invisible side facing the engine compartment. On the side facing the vehicle interior the gas bag emerges through an opening in the instrument carrier. In most cases, this opening is closed off by a flap provided with a tear line.

It is also known to provide the fastening plate with a screen and to install the gas bag module in the instrument carrier from the front. In the screen there is provided an opening mechanism through which the gas bag emerges.

The disadvantage of both solutions is that they require a large space, are very heavy and their assembly is complicated. Particularly critical is that the unavoidable manufacturing tolerances have to be adjusted at a high expense. All in all, this results in high production cost.

It is an object of the invention to provide a gas bag module, in particular for a knee gas bag, this gas bag module being distinguished by low production cost.

### BRIEF SUMMARY OF THE INVENTION

The gas bag module according to the invention includes a housing, a gas generator and a gas bag. The gas generator and the gas bag form a unit which is floatingly mounted in the interior of the housing. The gas bag module according to the invention is distinguished in that no complicated tolerance adjustment is required. The housing is installed in the instrument carrier. The gas generator and the gas bag attached thereto may be fitted to a carrier associated therewith, for example a cross bar in the interior of the instrument carrier. Since the gas generator and the gas bag are floatingly mounted in the interior of the housing, any manufacturing tolerances may automatically be adjusted; both the gas generator and the gas bag automatically assume the required position in the interior of the housing. In this manner a simple construction is achieved, which is distinguished by a low weight and small manufacturing cost.

Preferably, the housing is made of plastic. It encloses the unit formed of the gas generator and the gas bag so that these components are protected from external influences such as dust, dirt, bumps, etc. By appropriately designing the housing, in particular by appropriately selecting the wall thickness and providing reinforcement ribs, the housing may adopt the function of an ejection channel. Moreover, the absorption of the response forces is possible.

Advantageous embodiments of the invention will be apparent from the sub-claims.

### DETAILED DESCRIPTION OF THE INVENTION

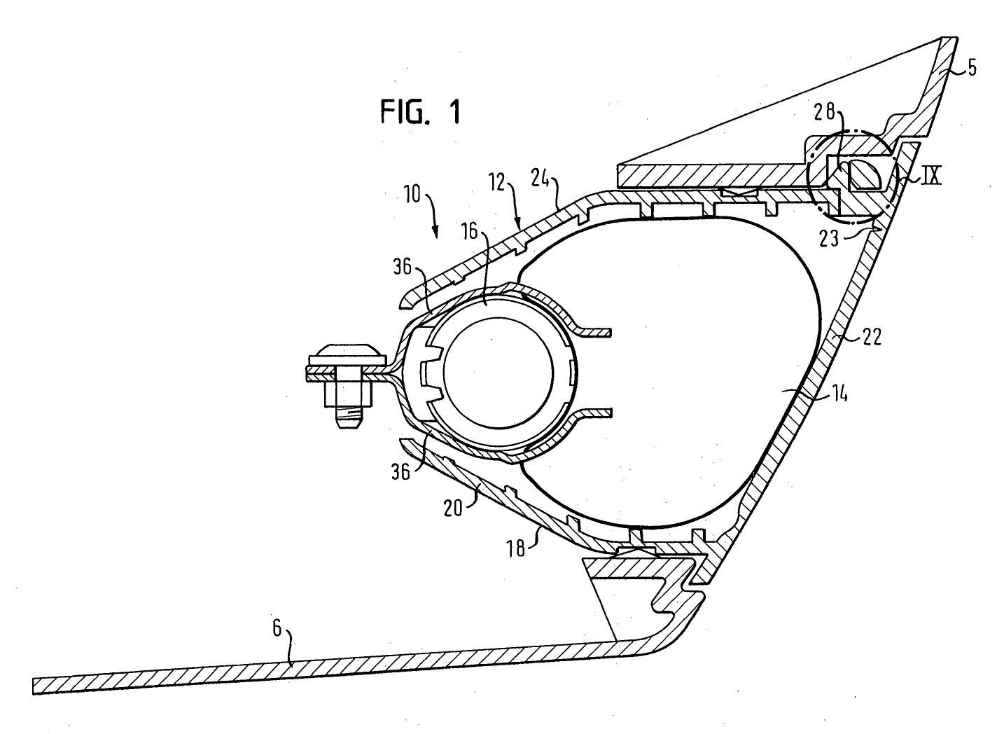

FIG. 1 shows a cross-section through a gas bag module in accordance with the invention, the gas bag module being placed in an instrument carrier;

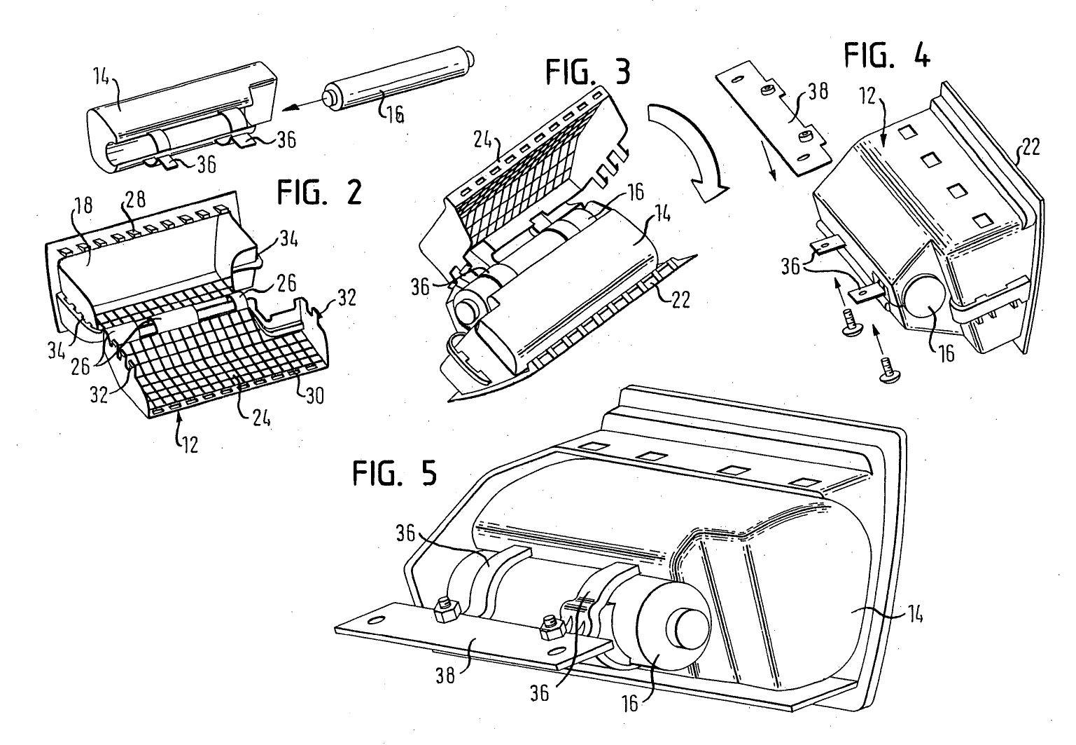

FIGS. 2 to 4 show various assembly steps of the gas bag module;

FIG. 5 shows the unit formed of the gas generator and the gas bag arranged in the interior of the housing;

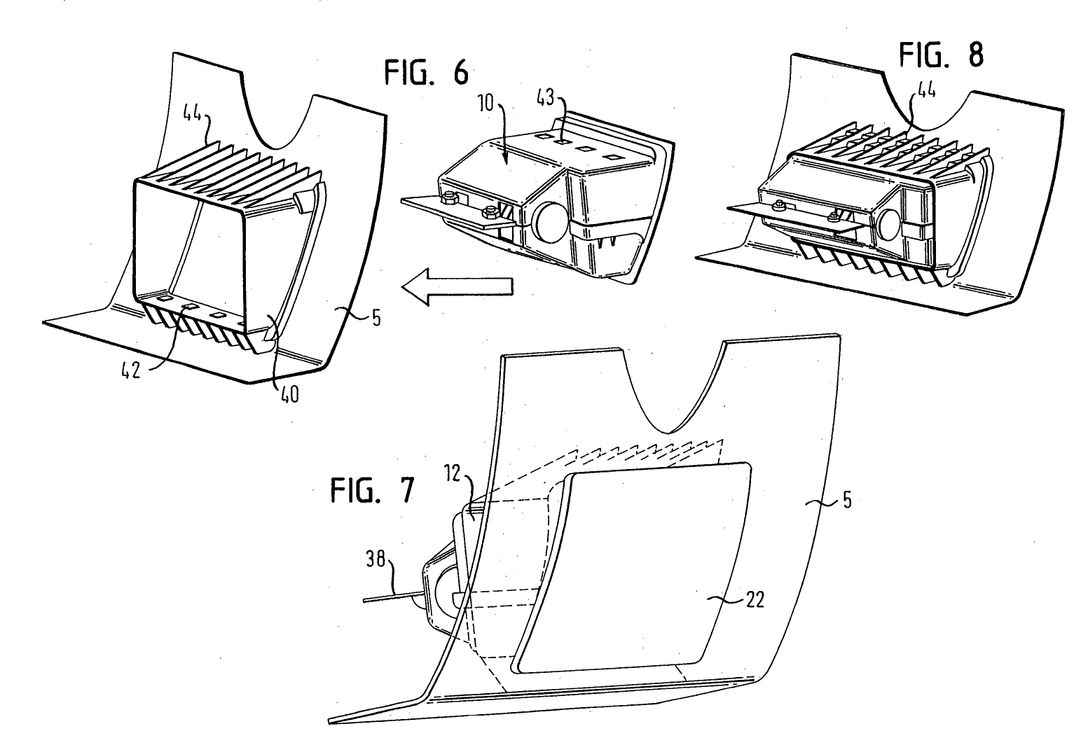

FIG. 6 shows the fitting of the assembled gas bag module in an instrument carrier;

FIGS. 7 and 8 show various views of the assembled gas bag module; and

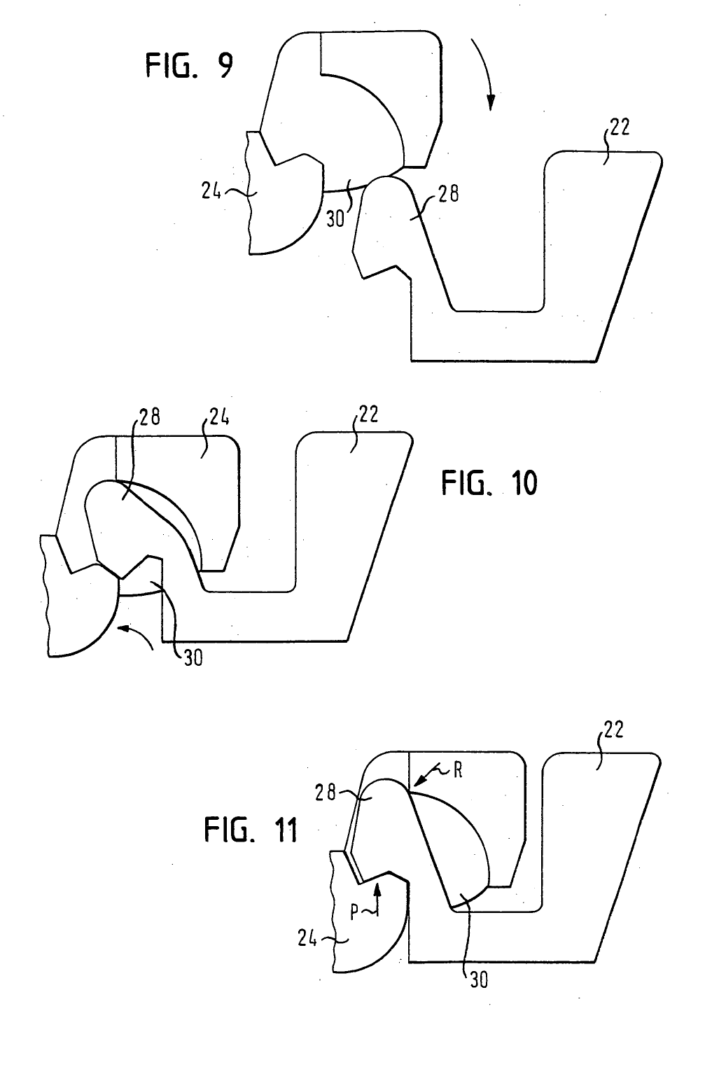

FIGS. 9 to 11 show the latching lugs used for closing off the housing prior to closing, during closing and after closing.

In FIG. 1 there is shown an instrument carrier 5 holding, for example at the driver side, instruments such as a speedometer or a revolution counter or, at the front passenger side, a glove compartment. In the lower region of the instrument carrier 5, i.e. in the transition portion to a section 6 facing the foot space, there is provided a gas bag module 10 comprising a housing 12, a gas bag 14 and a gas generator 16. After the gas generator 16 has been activated, it serves to make available a volume of gas under pressure, this gas being fed into the gas bag 14 to enable the latter to deploy from a compactly folded initial state so that it may provide a restraining effect for a vehicle occupant.

The housing 12 (see also FIG. 2) consists of two parts, namely a trough-like first housing part 18 having a side wall 20 and a front wall 22, and a second housing part 24 constituting a second side wall. The two housing parts 18, 24 are integrally connected to each other by several film hinges 26. Along the edge of the front wall 22 there are provided a plurality of latching lugs 28 (see also FIG. 9), with openings 30 being associated therewith at the edge of the second housing part 24 opposite to the film hinge 26. On the front faces of the second housing part there are further provided hooks 32 which are adapted to engage in openings 34 on the front faces of the first housing part 18.

For the assembly, the gas generator 16 is inserted in two holding lugs 36 which are attached to a holding plate (not shown) in the interior of the folded gas bag 14. The unit formed in this manner is placed in the housing 12, namely in the trough-like housing part 18 (see FIG. 3). In so doing, the folded gas bag 14 rests on the front wall 22 and the holding lugs 36 extend outwards through the portion between the two housing parts 18, 24, i.e. through the space between the film hinges 26. The second housing part 24 is then turned down so that the holding lugs 28 and the hooks 32 pass through the corresponding openings. This is shown in detail for the latching lugs 28 in FIGS. 9 to 11.

The latching lugs 28 enter the openings 30 at the second housing part 24 and are bent over on account of the particular, channel-like shape of the openings 30 (see FIG. 10) until they have completely passed through the opening 30. They straighten up again then (see FIG. 11) so that they support themselves at a latching lug. If a force were exerted on the second housing part 24 trying to open the housing, the latching lug 28 would engage a shoulder behind the opening, this shoulder being restrained by the latching lug 28 (see the arrow P of FIG. 11). The force exerted on the latching lug 28 in the process tries to bend up the latter clockwise with regard to FIG. 11. This is counteracted by a supporting edge behind the opening 30 at the second housing part (see the arrow R). Thus, the housing is reliably kept closed.

An anchoring plate 38 (see FIGS. 4 and 5) may further be attached to the holding lugs 36 protruding from the housing 12.

When the housing 12 is closed, the unit formed by the folded gas bag 14 and the gas generator 16 is free to move in the interior of the housing 12. The holding lugs 36 extending outwardly through the gap between the first and second housing parts 18, 24 are movable in this gap in every spatial direction.

The instrument carrier 5 is provided with a mount 40 (see FIG. 6) into which the gas bag module 10 may be inserted. The mount 40 is designed as a surrounding frame which is provided with latching protrusions 42 at two mutually opposite sides, these latching protrusions 42 being adapted to engage in latching recesses 44 at the side parts of the housing 12. The gas bag module 10 may be inserted into the mount 40 from the side of the vehicle interior (see FIG. 6) until the latching protrusions 42 lock into place in the latching recesses 44. When the gas bag module 10 has completely been inserted, the front wall 22 closes off flush with the outside of the instrument carrier 5 (see also FIG. 7). In this state the anchoring plate 38 extends on the rear of the mount 40 (see FIG. 8) where it may be attached to a vehicle-fixed carrier.

After the gas generator has been activated, the gas bag 14 starts to deploy. Thereby, the front wall 22 is separated from the housing 12 along a tear line 23 so that it swings open and opens an exit port for the gas bag 14. The carrier behind the instrument carrier takes up the response forces during activation of the gas bag module.

Since the unit formed by the gas bag 14 and the gas generator 16 is floatingly mounted in the interior of the housing 12, no special precautions for a tolerance adjustment are necessary; when the holding lugs 36 of the gas generator 16 are attached to the carrier, the gas generator, together with the gas bag, automatically orients itself correctly in the interior of the housing 12.

As can be seen in FIGS. 6 and 8, the mount 40 is provided on its outside with reinforcement ribs 44. These ribs 44 serve as a stabilization so that upon activation of the gas bag module 10 the response forces that try to expand the housing 12 upwards and downwards with respect to FIG. 8 can reliably be taken up. The response forces which result from the gas bag 14 emerging and which act in the horizontal direction with respect to FIG. 8 are taken up by the carrier.

1. A gas bag module (10), in particular for a knee gas bag, including a housing (12), a gas generator (16) and a gas bag (14), characterized in that the gas generator (16) and the gas bag (14) form a unit which is floatingly mounted in the interior of the housing (12).

2. The gas bag module according to claim 1, characterized in that the housing (12) is made of plastic.

3. The gas bag module according to claim 1, characterized in that the housing (12) comprises two parts (18, 24) which are connected to each other by a film hinge (26).

4. The gas bag module according to claim 3, characterized in that one of the housing parts is trough-shaped and has a front wall (22) and a side wall (20) and the second housing part (24) has a side wall.

5. The gas bag module according to claim 4, characterized in that in the region of the front wall (22) at least one tear line (23) is provided.

6. The gas bag module according to claim 3, characterized in that the two housing parts (18, 24) are locked with each other.

7. The gas bag module according to claim 3, characterized in that close to the front wall (22) the trough-shaped housing part (18) is provided with a plurality of latching lugs (28) reaching through openings (30) in the second housing part (24).

8. The gas bag module according to claim 1, characterized in that holding lugs (36) engage the gas generator (16), said holding lugs (36) extending outwards through the housing (12).

9. The gas bag module according to claim 1, characterized in that the housing (12) is placed in a mount (40) in an instrument carrier (5).

10. The gas bag module according to claim 9, characterized in that the housing (12) locks into place in the mount (40).

11. The gas bag module according to claim 9, characterized in that the mount (40) is provided with reinforcement ribs (44).

12. The gas bag module according to claim 1, characterized in that the housing (12) is constructed in one piece and in that the unit formed of the gas generator (16) and the gas bag (14) is attached in a vehicle-fixed manner.
